(19) United States
(12) Patent Application Publication
(10) Pub. No.: US 2016/0368319 A1
(43) Pub. Date: Dec. 22, 2016

(54) Balanced wheel swivel system without adding vertical dimension to wheel

(71) Applicant: Thomas Powwarynn, Los Angeles, CA (US)

(72) Inventor: Thomas Powwarynn, Los Angeles, CA (US)

(21) Appl. No.: 14/740,522

(22) Filed: Jun. 16, 2015

(51) Int. Cl. B60B 33/00

(52) U.S. Cl. CPC B60B 33/006

(57) ABSTRACT

A wheel swivel system without adding vertical dimension to wheel. The system allows chassis to be mounted lower than the wheel vertical height instead of on top of the wheel with swivel system in between. The system requires wheel, wheel shaft, wheel fork, and bearing large enough to accommodate the wheel size.

### FIELD OF THE INVENTION

The present invention relates to swivel wheel assembly for allowing wheel to swivel independently from supporting device.

### DESCRIPTION OF THE RELATED ART

Swivel wheels are used to support device which allow the supported device to roll and turn in different directions. Swivel wheel consist of a wheel, wheel fork, and rotatable cup which allows the wheel to swivel independently from the supported device. For example, U.S. Pat. No. 1,661,889 and U.S. Pat. No. 20,050,005,394 disclose swivel system having socket member or bearings mounted on the wheel fork as swivel mechanism for the wheel. These systems add vertical dimension to the wheel. Adding socket member to one side of the wheel can provide swivel function to the wheel without adding vertical dimension per U.S. Pat. No. 5,408,723, but the design focuses pressure to one side of the wheel and causes wheel to wobble when rolling under load.

### BACKGROUND OF THE INVENTION

Swivel system on wheel or caster is typically mounted on top of the wheel. The typical system adds vertical height to the wheel. When low profile setup is required, wheel size needs to be reduced to accommodate swivel system which result in compromised wheel construction and traction material. Smaller wheel with stiffer materials result in rough rolling across surfaces, less wheel traction, and less wheel load capacity.

### BRIEF SUMMARY OF THE INVENTION

Balanced wheel swivel system without adding vertical dimension to wheel allows chassis to be mounted within the vertical height of the wheel. The design allows maximum wheel size for the available vertical dimension. The system comprise of turntable bearing, low profile wheel fork, wheel shaft, and a wheel.

### BRIEF DESCRIPTON OF THE SEVERAL VIEWS OF THE DRAWINGS

FIG. 1 is a perspective view of the invention

FIG. 2 is an exploded view of the invention showing various parts

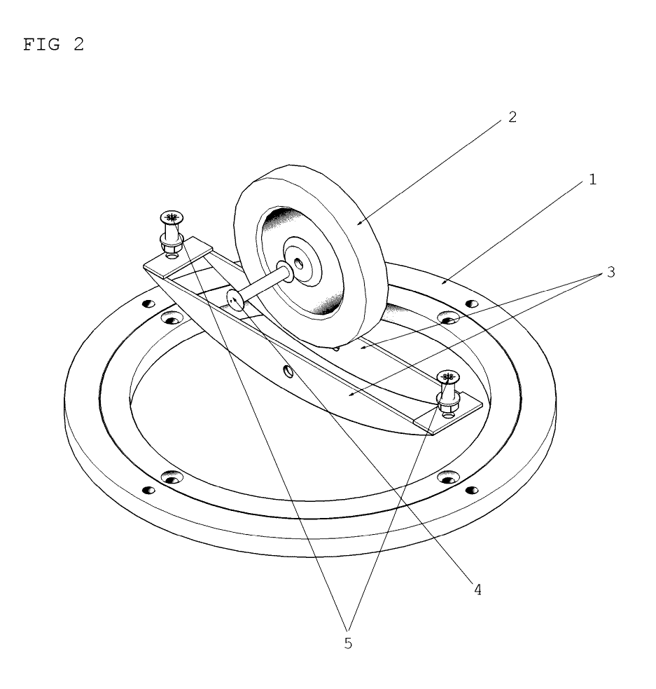

### DETAILED DESCRIPTION OF THE INVENTION

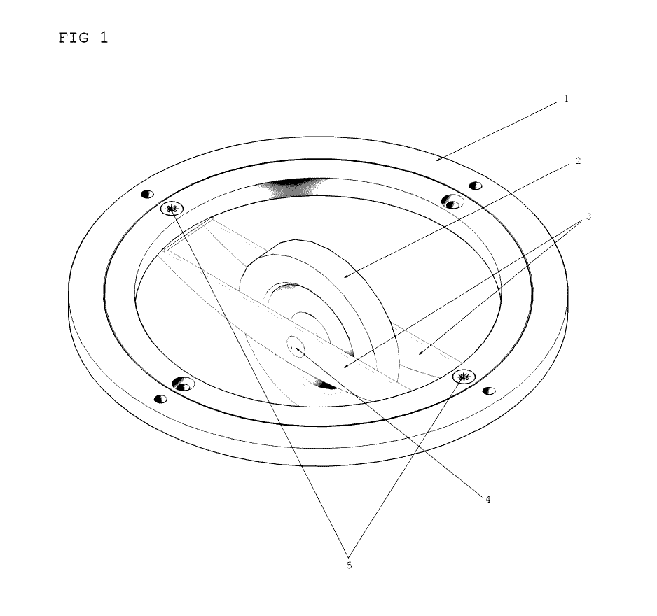

Referring to FIG. 1, the illustration represents perspective view of the assembled invention where wheel 2 is held inside and partially inserted into turntable bearing by low profile wheel fork 3 and wheel shaft 4. The size of the wheel 2 can be larger as long as it doesn't rub with inner turntable bearing bore when rolling. The wheel fork 3 is connected by two screws 5 to the inner ring of the turntable bearing 1. The outer ring of the turntable bearing is for connecting to chassis or device.

When higher ground clearance is required, larger wheel size can be used together with higher profile wheel fork. Wheel can be minimally inserted into inner turntable bearing bore which allow for larger diameter wheel.

What is claimed is:

1. A balance wheel swivel system without adding vertical dimension to wheel, comprising:
Turntable bearing with inner bore large enough to accommodate wheel partially inserted without rubbing when the wheel is spinning, and wheel shaft for holding and connecting wheel to the turntable bearing where both ends of the wheel shaft are securely connected to turntable bearing ring directly or wheel fork; once assembled the entire assembly is within wheel vertical height.

2. A balance wheel swivel system without adding vertical dimension to wheel,comprising:
Turntable bearing with inner bore large enough to accommodate wheel partially inserted without rubbing when the wheel is spinning, and wheel shaft holding the wheel and both ends of the shaft are connected to turntable bearing's ring; once assembled the entire assembly is within wheel vertical height.
